(19) United States
(12) Patent Application Publication
(10) Pub. No.: US 2023/0335945 A1
(43) Pub. Date: Oct. 19, 2023

(54) CONNECTOR

(71) Applicant: SHANGHAI SHENGZHE MEDICAL TECHNOLOGY CO., LTD., Shanghai (CN)

(72) Inventor: Xianglu WU, Shanghai (CN)

(21) Appl. No.: 18/044,662

(22) PCT Filed: Aug. 6, 2021
(86) PCT No.: PCT/CN2021/111074

§ 371 Date: Mar. 9, 2023

(30) Foreign Application Priority Data
Sep. 9, 2020 (CN) 202010942400.X

(51) Int. Cl. H01R 13/62; H01R 13/629; H01R 13/05; H01R 13/11; H01R 13/508

(52) U.S. Cl. CPC H01R 13/6205; H01R 13/629; H01R 13/052; H01R 13/111; H01R 13/508; H01R 2201/12

(57) ABSTRACT

In an example embodiment, a connector includes a male base and a female base. The male base is inserted with a male end pin and a first connection member. The female base is detachably connected to the male base. The female base is inserted with a female end pin and a second connection member. After the female base is connected to the male base, the male end pin is connected to the female end pin, and the second connection member attracts the first connection member.

### CROSS-REFERENCE TO RELATED APPLICATIONS

This is a National Stage Application, filed under 35 U.S.C. 371, of International Patent Application No. PCT/CN2021/111074, filed on Aug. 6, 2021, which claims priority to Chinese patent application No. 202010942400.X filed on Sep. 9, 2020, contents of both of which are incorporated herein by reference in their entireties.

### TECHNICAL FIELD

The present application relates to the technical field of medical devices, for example, a connector.

### BACKGROUND

A connector is also referred to as a connector assembly, a plug, and a socket. The connector generally refers to an electrical connector, that is, a device that connects two active devices and transmits currents or signals. There are two main types of connectors on the market, one type of connector has a plug-in hand feel and another type of connector has no a plug-in hand feel. The advantage of the former is an obvious plug-in feel when inserting the connector, and the disadvantage is that components are often necessary to provide on the housing of the connector so that the connector has a plug-in hand feel in addition to the main functional components of the connector, which results in a larger volume of the connector as a whole. Another type of connector without a plug-in hand feel is low in cost and merely requires functional components of the connector; the disadvantage is that the connector has no plug-in hand feel, which makes the operator feel poor when inserting the connector.

### SUMMARY

The present application provides a connector which solves the problems that a connector with a plug-in feel uses many components and is high in cost.

The present application adopts technical solutions described below.

In an example embodiment, a connector includes a male base and a female base. The male base is inserted with a male end pin and a first connection member. The female base is detachably connected to the male base. The female base is inserted with a female end pin and a second connection member. After the female base is connected to the male base, the male end pin is connected to the female end pin, and the second connection member attracts the first connection member.

In example embodiments, the female base is provided with a first recess. A female end positioning block is disposed on the recess bottom of the first recess. A gap is disposed between the female end positioning block and a sidewall of the first recess. A first end of the male base is provided with a second recess. After the male base is connected to the female base, the first end of the male base is inserted into the gap, and the female end positioning block is disposed in the second recess.

In example embodiments, the middle portion of the female end positioning block is provided with a through hole along the insertion direction of the male base and the female base. The second connection member is installed in the through hole. The first connection member is disposed in the second recess. The first connection member is capable of being inserted into the through hole and connected to the second connection member.

In example embodiments, an elastic member is disposed in the through hole. The first connection member is capable of passing through the elastic member to be connected to the second connection member. When the first connection member passes through the elastic member, the elastic member is deformed outward along the radial direction of the through hole to clamp the first connection member.

In example embodiments, the first connection member includes a connection rod. The end of the connection rod connected to the second connection member is provided with a snap recess along the circumferential direction of the connection rod. The snap recess is recessed inward along the radial direction of the connection rod. The elastic member is capable of snapping into the snap recess.

In example embodiments, the elastic member is a crown spring.

In example embodiments, the connection rod is made of a ferromagnetic material. The second connection member includes a magnet. The magnet is capable of attracting the connection rod.

In example embodiments, a plurality of female end pins are provided. The female end positioning block is provided with a plurality of female end pin holes. Each female end pin hole is disposed along the insertion direction of the male base and the female base. One female end pin is disposed in one female end pin hole. A first end of the one female end pin is disposed in the one female end pin hole. A second end of the one female end pin passes through the one female end pin hole and disposed outside the female base.

In example embodiments, a plurality of male end pins are provided. A second end of the male base opposite to the second recess is provided with a third recess. A male end positioning block is disposed on the recess bottom of the third recess. A first end of a male end pin passes through the male end positioning block and disposed in the second recess. After the male base is connected to the female base, one male end pin is capable of being inserted into one female end pin hole and connected to the female pin in the one female end pin hole. A second end of the one male end pin is disposed in the third recess.

In example embodiments, an outer sidewall of the female base is securely connected to two positioning ears which are configured to secure the female base. The two positioning ears are disposed symmetrically.

### BRIEF DESCRIPTION OF DRAWINGS

FIG. 1 is a three-dimensional section view illustrating the internal structure of a connector according to an embodiment of the present application.

FIG. 2 is a three-dimensional diagram illustrating the external structure of a connector according to an embodiment of the present application.

### REFERENCE LIST

1 female base
2 female end pin
3 second connection member
4 elastic member
5 male base
6 male end pin
7 connection rod
11 female end positioning block
12 first recess
13 gap
14 positioning ear
111 through hole
112 female end pin hole
51 male end positioning block
52 second recess
53 third recess
71 snap recess

### DETAILED DESCRIPTION

The present application is described below in conjunction with drawings and embodiments. The embodiments described herein are merely intended to explain and not to limit the present application. For ease of description, only part, not all, of structures related to the present application are illustrated in the drawings.

In the description of the present application, unless otherwise expressly specified and limited, the term “connected to each other”, “connected”, or “secured” is to be construed in a broad sense, for example, as securely connected, detachably connected, or integrated; mechanically connected or electrically connected; directly connected to each other or indirectly connected to each other via an intermediary; or internally connected between two elements or interaction relations between two elements. For those of ordinary skill in the art, meanings of the preceding terms can be understood according to situations in the present application.

In the present application, unless otherwise expressly specified and limited, when a first feature is described as “on” or “below” a second feature, the first feature and the second feature may be in direct contact or be in contact via another feature between the first feature and the second feature instead of being in direct contact. When the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the description of the present application, it is to be noted that the orientations or position relations indicated by terms such as “above”, “below”, “right”, and the like are based on orientations or position relations shown in the drawings. These orientations or position relations are intended only to facilitate and simplify description of the present application, and not to indicate or imply that a device or element referred to must have such specific orientations or must be configured or operated in such specific orientations. Thus, these orientations or position relations are not to be construed as limiting the present application. In addition, the terms “first” and “second” are used only to distinguish between descriptions and have no special meaning.

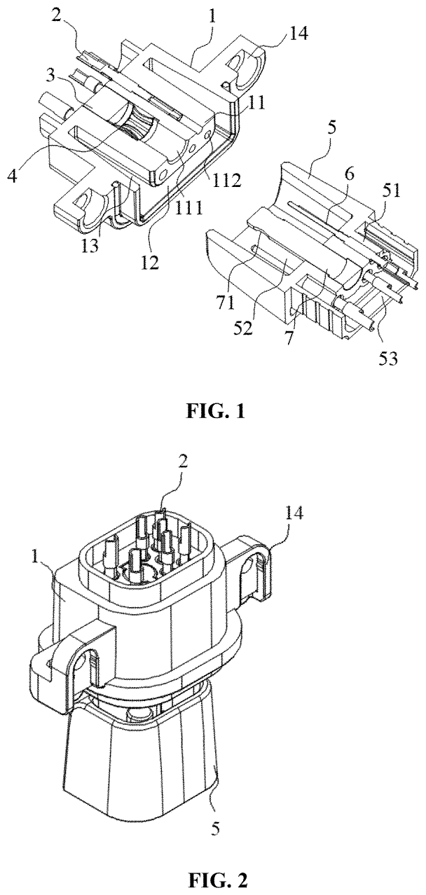

As shown in FIG. 1, the present application provides a connector. When the connector is plugged and unplugged, a first connection member on a male base 5 and a second connection member 3 on a female base 1 are connected or separated, and the hand feel of plugging and unplugging is generated, which brings a good use experience to the operator.

The connector includes the male base 5 and the female base 1. Male end pins 6 and the first connection member are inserted into the male base 5. Female end pins 2 and the second connection member 3 are inserted into the female base 1. After the male base 5 is connected to the female base 1, the male end pins 6 are connected to the female end pins 2, and the second connection member 3 attracts the first connection member. When the male base 5 is inserted into the female base 1, the second connection member 3 generates attraction to the first connection member so that the connector has the hand feel of plugging and unplugging during use. The male base 5 and the female base 1 are detachably connected, which is convenient for plugging and unplugging, installing, and detaching.

In this embodiment, the female base 1 is provided with a first recess 12. A female end positioning block 11 is disposed on the recess bottom of the first recess 12. A gap 13 is disposed between the female end positioning block 11 and a sidewall of the first recess 12. A first end of the male base 5 is provided with a second recess 52. After the male base 5 is connected to the female base 1, the first end of the male base 5 is inserted into the gap 13, and the female end positioning block 11 is disposed in the second recess 52. When the male base 5 is connected to the female base 1, the first recess 12 and the gap 13 produce a guiding effect to the male base 5, and the overall structure is convenient for detaching and installing and is easy to implement.

The middle portion of the female end positioning block 11 is provided with a through hole 111 along the insertion direction of the male base 5 and the female base 1. The second connection member 3 is installed in the through hole 111. The first connection member is disposed in the second recess 52. The first connection member is capable of being inserted into the through hole 111 and connected to the second connection member 3. When the connector is plugged and unplugged, the through hole 111 plays a guiding role and guides the operator to bring the first connection member close to the second connection member 3 and make the first connection member be sucked by the second connection member 3, which is convenient and quick to use.

An elastic member 4 is further disposed in the through hole 111. The first connection member is capable of passing through the elastic member 4 and connected to the second connection member 3. When the connector is plugged and unplugged, the first connection member expands the elastic member 4. The elastic member 4 is deformed outward along the radial direction of the through hole 111. At this time, the elastic member 4 generates resistance to the first connection member and clamps the first connection member. The elastic member 4 snaps into the first connection member, and the connection stability is good. When the connector is plugged and unplugged, there are both the resistance of the elastic member 4 and the attraction of the second connection member 3. The resistance of the elastic member 4 and the attraction of the second connection member 3 cooperate with each other and enhance the hand feel of plugging and unplugging.

The first connection member includes a connection rod 7. The end of the connection rod 7 connected to the second connection member 3 is provided with a snap recess 71 along the circumferential direction of the connection rod 7. The snap recess 71 is recessed inward along the radial direction of the connection rod 7. The elastic member 4 is capable of snapping into the snap recess 71. In this embodiment, the elastic member 4 may be a crown spring. The shape of the snap recess 71 cooperates with the shape of the crown spring. Since the crown spring has a structure with large diameters at two ends and a small diameter in the middle, when the connection rod 7 is inserted into the crown spring, the connection rod 7 first expands one end of the crown spring. As the connection rod 7 is inserted, the diameter of the contacted crown spring gradually decreases, and the insertion resistance gradually increases. When half the length of the snap recess 71 on the connection rod 7 is inserted into the crown spring, the resistance of the connection rod 7 gradually decreases, and finally the snap recess 71 slides into the crown spring. When plugging and unplugging, the resistance changes from large to small, which further enhances the hand feel of plugging and unplugging.

In this embodiment, the connection rod 7 is made of a ferromagnetic material. The second connection member 3 includes a magnet. The magnet is capable of attracting the connection rod 7. The connection rod 7 may be made of iron, cobalt, nickel, or alloy thereof. These materials are low in cost and convenient to use.

As shown in FIG. 1 and FIG. 2, in this embodiment, multiple female end pins 2 are provided. The female end positioning block 11 is provided with multiple female end pin holes 112 along the insertion direction of the male base 5 and female base 1. The multiple female end pin holes 112 surround the through hole 111. Each female end pin 2 is disposed in one female end pin hole 112. A first end of the each female end pin 2 is disposed in the one female end pin hole 112. A second end of the each female end pin 2 passes through the one female end pin hole 112 and disposed outside the female base 1.

With continuing reference to FIG. 1, multiple male end pins 6 are provided. A second end of the male base 5 opposite to the second recess 52 is provided with a third recess 53. A male end positioning block 51 is disposed on the recess bottom of the third recess 53. A first end of each male end pin 6 passes through the male end positioning block 51 and disposed in the second recess 52. A second end of the each male end pin 6 is disposed in the third recess 53. After the male base 5 is connected to the female base 1, each male end pin 6 can be inserted into one female end pin hole 112 and the each male end pin 6 is contacted with and connected to the female end pin 2 in the one female end pin hole 112 to implement the transmission of currents and signals.

The outer sidewall of the female base 1 is securely connected to two positioning ears 14 which are used for securing the female base 1. The two positioning ears 14 are disposed symmetrically. Each positioning ear 14 is provided with a screw hole. A screw is passed through the screw hole to secure the female base 1.

The connector in the present application includes a male base and a female base. Male end pins and a first connection member are disposed in the male base. Female end pins and a second connection member are disposed in the female base. After the male base is connected to the female base, the male end pins are connected to the female end pins to conduct currents and signals. When the male base is inserted into the female base, the second connection member generates attraction to the first connection member so that the connector has the hand feel of plugging and unplugging during use.

1. A connector, comprising:
a male base, wherein the male base is inserted with a male end pin and a first connection member; and
a female base detachably connected to the male base, wherein the female base is inserted with a female end pin and a second connection member; and after the female base is connected to the male base, the male end pin is connected to the female end pin, and the second connection member attracts the first connection member.

2. The connector according to claim 1, wherein the female base is provided with a first recess, a female end positioning block is disposed on a recess bottom of the first recess, and a gap is disposed between the female end positioning block and a sidewall of the first recess; a first end of the male base is provided with a second recess; and after the male base is connected to the female base, the first end of the male base is inserted into the gap, and the female end positioning block is disposed in the second recess.

3. The connector according to claim 2, wherein a middle portion of the female end positioning block is provided with a through hole along an insertion direction of the male base and the female base, the second connection member is installed in the through hole, the first connection member is disposed in the second recess, and the first connection member is capable of being inserted into the through hole and connected to the second connection member.

4. The connector according to claim 3, wherein an elastic member is disposed in the through hole, the first connection member is capable of passing through the elastic member to be connected to the second connection member, and in a case where the first connection member passes through the elastic member, the elastic member is configured to be deformed outward along a radial direction of the through hole to clamp the first connection member.

5. The connector according to claim 4, wherein the first connection member comprises a connection rod, an end of the connection rod connected to the second connection member is provided with a snap recess along a circumferential direction of the connection rod, the snap recess is recessed inward along a radial direction of the connection rod, and the elastic member is capable of snapping into the snap recess.

6. The connector according to claim 4, wherein the elastic member is a crown spring.

7. The connector according to claim 5, wherein the connection rod is made of a ferromagnetic material, the second connection member comprises a magnet, and the magnet is capable of attracting the connection rod.

8. The connector according to claim 2, wherein a plurality of female end pins are provided; the female end positioning block is provided with a plurality of female end pin holes, and each female end pin hole of the plurality of female end pin holes is disposed along an insertion direction of the male base and the female base; each female end pin of the plurality of female end pins is disposed in one of the plurality of female end pin holes, a first end of the each female end pin is disposed in the one of the plurality of female end pin holes, and a second end of the each female end pin is configured to pass through the one of the plurality of female end pin hole and disposed outside the female base.

9. The connector according to claim 8, wherein a plurality of male end pins are provided; a second end of the male base opposite to the second recess is provided with a third recess, and a male end positioning block is disposed on a recess bottom of the third recess; a first end of each male end pin of the plurality of male end pins passes through the male end positioning block and is disposed in the second recess; and after the male base is connected to the female base, the each male end pin is capable of being inserted into one female end pin hole of the plurality of female end pin holes and connected to a female pin in the one female end pin hole, and a second end of the each male end pin is disposed in the third recess.

10. The connector according to claim 1, wherein an outer sidewall of the female base is securely connected to two positioning ears configured to secure the female base, and the two positioning ears are disposed symmetrically.
